(19) United States
(12) Patent Application Publication
(10) Pub. No.: US 2003/0111947 A1
(43) Pub. Date: Jun. 19, 2003

(54) Low operating temperature light source

(76) Inventor: Holger Claus, Lake Forest, CA (US)

Correspondence Address: COUDERT BROTHERS LLP, 333 SOUTH HOPE STREET, 23RD FLOOR, LOS ANGELES, CA, 90071, US

(21) Appl. No.: 10/017,286

(22) Filed: Dec. 13, 2001

(51) Int. Cl. H01J 5/50; H01J 5/58

(52) U.S. Cl. 313/318.08

(57) ABSTRACT

The present invention provides a low operating temperature bulb and a method for manufacturing the bulb. In one embodiment, the second bulb of the double bulb is affixed to the second base using an adhesive which forms a seal as it cures. In one embodiment, two surfaces of the second bulb are affixed to the second base with an adhesive. In another embodiment, the second base extends beyond the outer surface of the second bulb. Thus, a lip is formed around the double bulb which can be clasped to hold the second bulb in place. In yet another embodiment, three surfaces of the second bulb are affixed to the second base with an adhesive. A groove in the second base accepts the end of the second bulb. Thus, the interior surface, exterior surface and end surface of the second bulb are affixed to the second base.

### BACKGROUND OF THE INVENTION

1. Field of the Invention

The present invention relates to the field of light sources, and in particular to a method and apparatus for a low operating temperature light source.

2. Background Art

Light bulbs can become very hot. For example, a small filament bulb has a surface temperature of about 280 degrees centigrade. In some applications, it is desirable to have a lower surface temperature, for example about 160 degrees centigrade. One method for reducing the surface temperature of a light source is to enclose the lamp housing, or bulb, in a second housing, resulting in what is termed a “double bulb”. However, prior art methods of assembling double bulbs produce an unacceptable number of double bulbs with defective and weak seals. This problem can be better understood with a review of double bulbs.

Double Bulbs

In some circumstances, the surface of a light source becomes unacceptably hot. One method of reducing the surface temperature is to enclose the lamp housing in a second housing, thus making the total exterior surface area larger. With the larger surface area of the second housing, the heat produced by the light source is spread over a greater area. As a result, the temperature on the surface of the double bulb is lower.

FIG. 1 illustrates a double bulb that has two bases. A second base 100 is placed next to the base 110 of the first lamp housing 120. The leads 130 of the first lamp housing pass through the second base. Then, a second bulb 140 is placed over the lamp housing such that the second base is positioned at the open end of the second bulb. A seal is formed between the second base and the second bulb by applying sufficient heat to melt the second base and the second bulb together.

However, due to the different heat expansion properties of the second base and the second bulb, the seal is frequently defective. Additionally, if the lamp housing is sealed using the same method, it is important not to heat the double bulb to the temperature at which the seal of the lamp housing melts. Melting the seal of the lamp housing while sealing the second housing typically results in a defect in the double bulb.

### SUMMARY OF THE INVENTION

The present invention provides a low operating temperature light source and a method for manufacturing the low operating temperature light source. In one embodiment, the second bulb of a double bulb is affixed to the second base using an adhesive which forms a seal as it cures. Since the double bulb is not heated to a temperature which would melt the second base or second bulb, the different heat expansion properties of the second base and second bulb do not cause a defective seal of the second bulb. Likewise, the seal of the lamp housing is not melted.

In one embodiment, two surfaces of the second bulb are affixed to the second base with an adhesive. The interior surface and the end surface of the second bulb are affixed to the second base. Thus, the seal is stronger and less likely to be defective. In another embodiment, the second base extends beyond the outer surface of the second bulb. Thus, a lip is formed around the double bulb which can be clasped to hold the second bulb in place. In yet another embodiment, three surfaces of the second bulb are affixed to the second base with an adhesive. A groove in the second base accepts the end of the second bulb. Thus, the interior surface, exterior surface and end surface of the second bulb are affixed to the second base.

### BRIEF DESCRIPTION OF THE DRAWINGS

These and other features, aspects and advantages of the present invention will become better understood with regard to the following description, appended claims and accompanying drawings where:

FIG. 1 is a block diagram of a prior art double bulb.

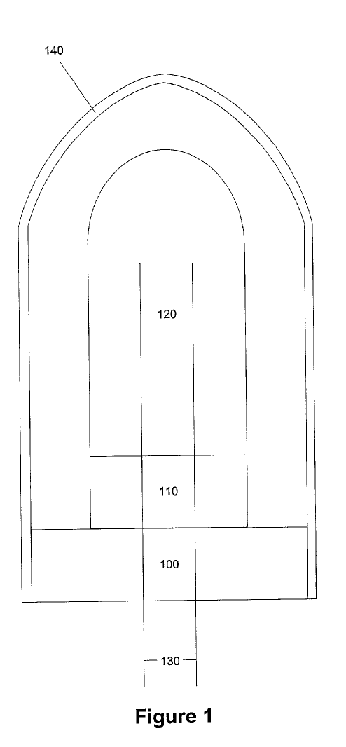

FIG. 2 is a block diagram of a double bulb in accordance with one embodiment of the present invention.

FIG. 3 is a flow diagram of the process of making a double bulb in accordance with one embodiment of the present invention.

FIG. 4 is a block diagram of a double bulb wherein the second bulb is affixed to the second base with an adhesive on two surfaces in accordance with one embodiment of the present invention.

FIG. 5 is a block diagram of a double bulb with a lip in accordance with one embodiment of the present invention.

FIG. 6 is a block diagram of a double bulb wherein the second bulb is affixed to the second base with an adhesive on three surfaces in accordance with one embodiment of the present invention.

### DETAILED DESCRIPTION OF THE INVENTION

The invention is a low operating temperature light source and a method for manufacturing the low operating temperature light source. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

Adhesive to Form Seal

In one embodiment, the second bulb of a double bulb is affixed to the second base using an adhesive which forms a seal as it cures. Since the double bulb is not heated to a temperature which would melt the second base or second bulb, the different heat expansion properties of the second base and second bulb do not cause a defective seal of the second bulb. Likewise, the seal of the lamp housing is not melted.

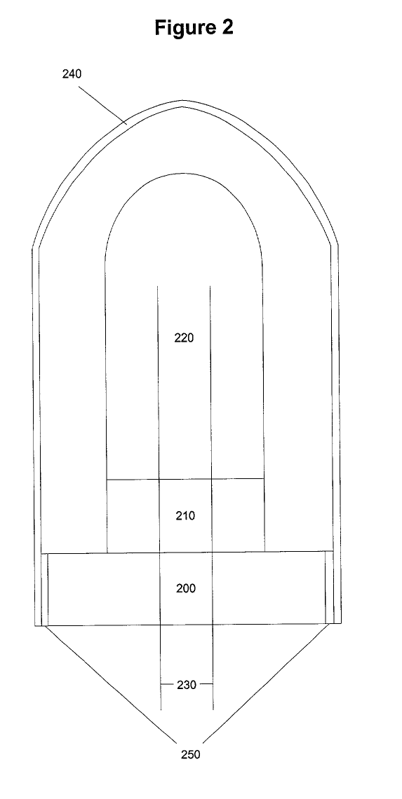

FIG. 2 illustrates a double bulb in accordance with one embodiment of the present invention. A second base 200 is placed next to the base 210 of the lamp housing 220. The leads 230 of the lamp housing pass through the second base. Then, a second bulb 240 is placed over the lamp housing such that the second base is positioned at the open end of the second bulb. An adhesive 250 is positioned in the gap between the second base and the second bulb. When the adhesive cures, a seal is formed and the double bulb is ready for use. Acceptable adhesives are ones which will not break down and lose the seal of the double bulb under normal operating conditions (e.g., temperature) of the bulb.

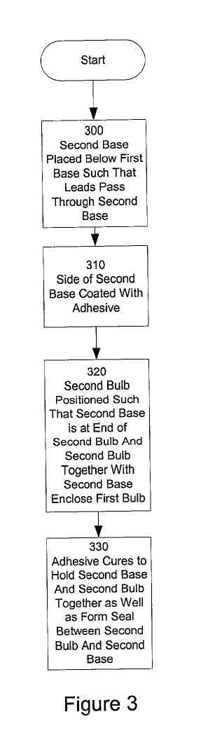

FIG. 3 illustrates the process of making a double bulb in accordance with one embodiment of the present invention. At step 300, a second base is placed below the first base such that the leads pass through the second base. At step 310, the side of the second base is coated with an adhesive. At step 320, a second bulb is positioned such that the second base is at the end of the second bulb and the second bulb together with the second base enclose the lamp housing. There is sufficient adhesive to fill the gap between the second base and the second bulb. At step 330, the adhesive cures to hold the second base and second bulb together as well as form a seal between the second bulb and the second base.

The process above may be modified to sufficiently coat the interior surface of the bulb with the adhesive instead of, or in addition to, the second base. Additionally, the adhesive may be injected between the second bulb and the second base once they are in the position indicated by step 320.

Two Surface Seal

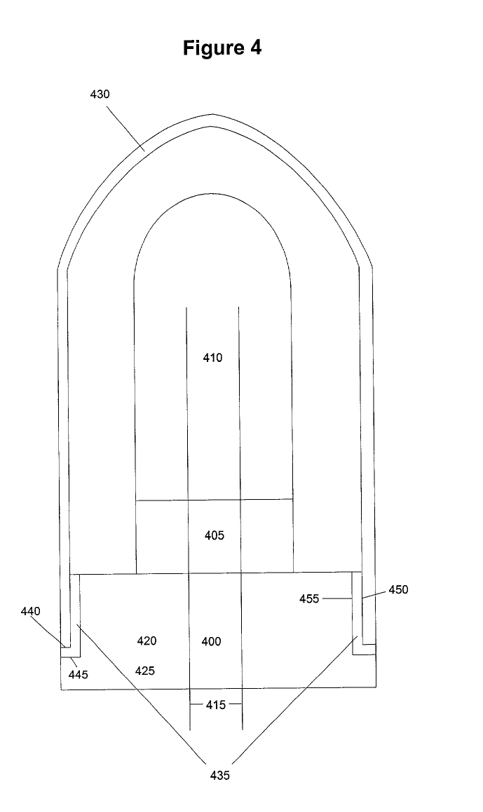

In one embodiment, two surfaces of the second bulb are affixed to the second base with an adhesive. The interior surface and the end surface of the second bulb are affixed to the second base. Thus, the seal is stronger and less likely to be defective. FIG. 4 illustrates a double bulb wherein the second bulb is affixed to the second base with an adhesive on two surfaces in accordance with one embodiment of the present invention. A second base 400 is placed next to the base 405 of the lamp housing 410. The leads 415 of the lamp housing pass through the second base. The second base has a top portion 420 and a bottom portion 425. The bottom portion has a larger radius than the top portion.

A second bulb 430 is placed over the lamp housing such that the second base is positioned at the open end of the second bulb. An adhesive 435 is used to affix the end surface 440 of the second bulb to the top surface 445 of the bottom portion of the second base and to affix the interior surface 450 of the second bulb to the side surface 455 of the top portion of the second base.

Clamping Lip on Double Bulb

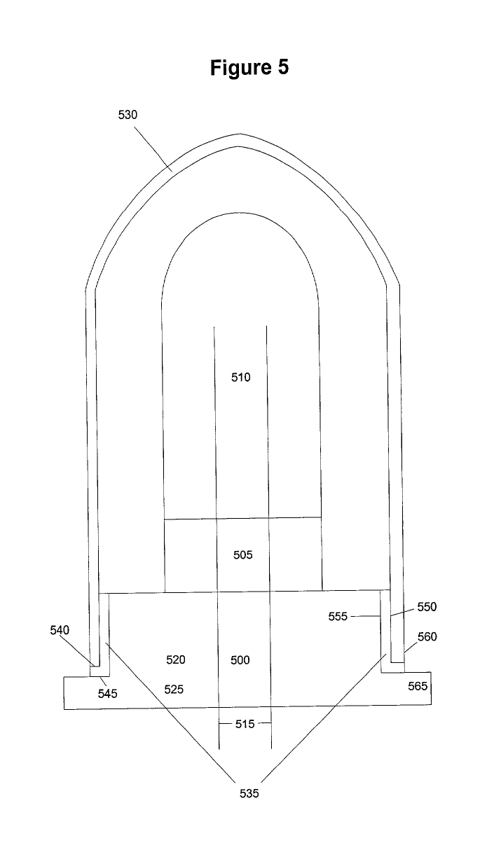

In another embodiment, the second base extends beyond the outer surface of the second bulb. Thus, a lip is formed around the double bulb which can be clasped to hold the second bulb in place. FIG. 5 illustrates a double bulb with a lip in accordance with one embodiment of the present invention. A second base 500 is placed next to the base 505 of the lamp housing 510. The leads 515 of the lamp housing pass through the second base. The second base has a top portion 520 and a bottom portion 525. The bottom portion has a larger radius than the top portion.

A second bulb 530 is placed over the lamp housing such that the second base is positioned at the open end of the second bulb. An adhesive 535 is used to affix the end surface 540 of the second bulb to the top surface 545 of the bottom portion of the second base and to affix the interior surface 550 of the second bulb to the side surface 555 of the top portion of the second base. The bottom portion of the second base extends beyond the exterior surface 560 of the second bulb. The portion of the second base that extends beyond the exterior second bulb forms a lip 565. In one embodiment, the double bulb is secured to a system by a clamp which is attached to the system and clamps onto the lip of the double bulb.

Three Surface Seal

In yet another embodiment, three surfaces of the second bulb are affixed to the second base with an adhesive. A groove in the second base accepts the end of the second bulb. Thus, the interior surface, exterior surface and end surface of the second bulb are affixed to the second base.

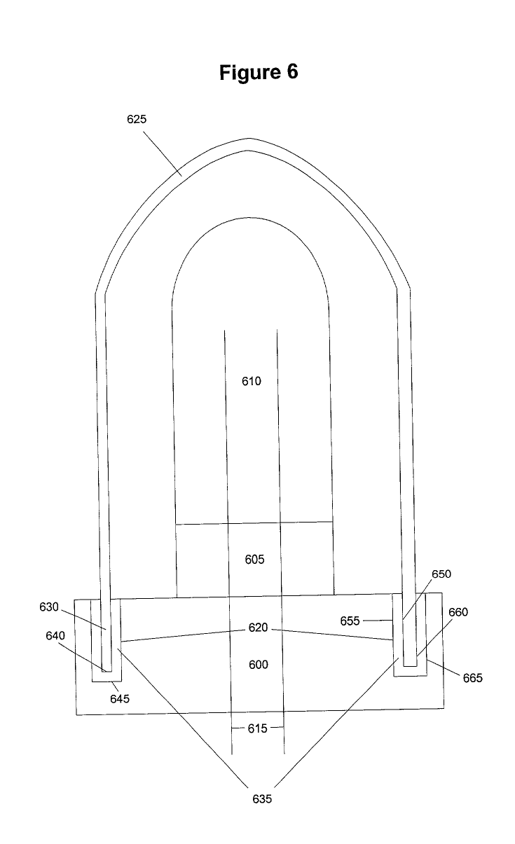

FIG. 6 illustrates a double bulb wherein the second bulb is affixed to the second base with an adhesive on three surfaces in accordance with one embodiment of the present invention. A second base 600 is placed next to the base 605 of the lamp housing 610. The leads 615 of the lamp housing pass through the second base. The second base has a groove 620 cut out on the top side.

A second bulb 625 is placed over the lamp housing such that the second base is positioned at the open end of the second bulb. Additionally, the end 630 of the second bulb fits into the groove of the second base. An adhesive 635 is used to affix the end surface 640 of the second bulb to the bottom surface 645 of the groove, the interior surface 650 of the second bulb to the interior surface 655 of the groove, and the exterior surface 660 of the second bulb to the exterior surface 665 of the groove.

Thus, a low operating temperature light source and a method for manufacturing the low operating temperature light source is described in conjunction with one or more specific embodiments. The invention is defined by the following claims and their full scope and equivalents.

1. A method for assembling a low operating temperature light source comprising:
positioning a second base next to a first bulb wherein a lead of said first bulb passes through said second base;
positioning a second bulb wherein a portion of said second base is encircled by an open end of said second bulb and wherein said second bulb and second base together enclose said first bulb;
positioning an adhesive between a first surface of said second base and an interior surface of said second bulb; and
curing said adhesive wherein said cured adhesive forms a seal between said second bulb and said second base.

2. The method of claim 1 further comprising:
positioning said adhesive between a second surface of said second base and an end surface of said second bulb.

3. The method of claim 2 further comprising:
positioning said adhesive between a third surface of said second base and an exterior surface of said second bulb.

4. The method of claim 1 further comprising:
providing an extension of said second base for use in clamping said double bulb in place.

5. A low operating temperature light source comprising:
a first bulb;
a second base positioned next to a first bulb wherein a lead of said first bulb passes through said second base;
a second bulb wherein a portion of said second base is encircled by an open end of said second bulb and wherein said second bulb and second base together enclose said first bulb; and
an adhesive positioned between a first surface of said second base and an interior surface of said second bulb wherein curing said adhesive forms a seal between said second bulb and said second base.

6. The low operating temperature light source of claim 5 wherein said adhesive is also positioned between a second surface of said second base and an end surface of said second bulb.

7. The low operating temperature light source of claim 6 wherein said adhesive is also positioned between a third surface of said second base and an exterior surface of said second bulb.

8. The low operating temperature light source of claim 5 further comprising:
a lip on said second base wherein said lip extends beyond an exterior surface of said second bulb.
